(19) United States
(12) Patent Application Publication
(10) Pub. No.: US 2026/0289610 A1
(43) Pub. Date: Sep. 24, 2026

(54) ADVERTISEMENT DISPLAY DEVICE, ADVERTISEMENT DISPLAY METHOD, AND NON-TRANSITORY COMPUTER-READABLE MEDIUM

(71) Applicant: NEC Corporation, Tokyo (JP)

(72) Inventors: Yasuhiko YOSHIDA, Tokyo (JP); Rui KONDO, Tokyo (JP); Shinnosuke NISHIMOTO, Tokyo (JP)

(73) Assignee: NEC Corporation, Tokyo (JP)

(21) Appl. No.: 19/432,324

(22) Filed: Dec. 24, 2025

(30) Foreign Application Priority Data
Mar. 18, 2025 (JP) 2025-043983

(51) Int. Cl. G06Q 30/0251; G06Q 30/0241; G06Q 30/0272

(52) U.S. Cl. CPC G06Q 30/0271; G06Q 30/0255; G06Q 30/0272; G06Q 30/0277

(57) ABSTRACT

An advertisement display device includes a space ID acquisition unit that acquires a space ID specifying a metaverse space, a spatial attribute prediction unit that predicts a spatial attribute based on object information, color information, and theme in the metaverse space specified by acquiring the space ID, an advertisement attribute acquisition unit that acquires attributes of candidates of a plurality of the advertisements, a displaying advertisement selection unit that selects an advertisement to display from the candidates of the plurality of the advertisements based on the predicted spatial attribute and the attributes of the plurality of the advertisements, and an advertisement display unit that displays the selected advertisement at a specific place in the metaverse space.

### INCORPORATION BY REFERENCE

This application is based upon and claims the benefit of priority from Japanese patent application No. 2025-043983, filed on Mar. 18, 2025, the disclosure of which is incorporated herein in its entirety by reference.

### TECHNICAL FIELD

The present disclosure relates to an advertisement display device, an advertisement display method, and a program.

### BACKGROUND ART

JP 2013-8256 A discloses that advertisement distribution by behavioral targeting is performed based on user's behavior information.

### SUMMARY

However, there has been no advertisement display device that comes out with an advertisement that matches the atmosphere of the space in the metaverse space. Therefore, an example object of the present disclosure is to provide an advertisement display device that selects and displays an advertisement based on a spatial attribute of a metaverse space and an attribute of the advertisement.

An advertisement display device according to a first example aspect of the present disclosure is an advertisement display device including
a space ID acquisition unit that acquires a space ID specifying a metaverse space,
a spatial attribute prediction unit that predicts a spatial attribute based on object information, color information, and theme in the metaverse space specified by acquiring the space ID,
an advertisement attribute acquisition unit that acquires attributes of candidates of a plurality of the advertisements,
a displaying advertisement selection unit that selects an advertisement to display from the candidates of the plurality of the advertisements based on the predicted spatial attribute and the attributes of the plurality of the advertisements, and
an advertisement display unit that displays the selected advertisement at a specific place in the metaverse space.

An advertisement display method according to a second example aspect of the present disclosure is an advertisement display method including
acquiring a space ID specifying a metaverse space,
predicting a spatial attribute based on object information, color information, and theme in the metaverse space specified by acquiring the space ID,
acquiring attributes of candidates of a plurality of the advertisements, and
selecting an advertisement to display from the candidates of the plurality of the advertisements based on the predicted spatial attribute and the attributes of the plurality of the advertisements, and
displaying the selected advertisement at a specific place in the metaverse space.

A program according to a third example aspect of the present disclosure is a program for causing an information processing device to execute
acquiring a space ID specifying a metaverse space,
predicting a spatial attribute based on object information, color information, and theme in the metaverse space specified by acquiring the space ID,
acquiring attributes of candidates of a plurality of the advertisements, and
selecting an advertisement to display from the candidates of the plurality of the advertisements based on the predicted spatial attribute and the attributes of the plurality of the advertisements, and
displaying the selected advertisement at a specific place in the metaverse space.

According to the present disclosure, an example advantage is that an advertisement display device that selects and displays an advertisement based on a spatial attribute of a metaverse space and an attribute of the advertisement can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an outline of a metaverse space according to the present disclosure;

FIG. 2 is a diagram illustrating display of an advertisement in the metaverse space according to the present disclosure;

FIG. 3 is a block diagram illustrating a configuration of an advertisement display device according to the present disclosure;

FIG. 4 is a flowchart of an advertisement display method according to the present disclosure; and

FIG. 5 is a block diagram illustrating a configuration of an information processing device according to the present disclosure.

### EXAMPLE EMBODIMENTS

### Description of Metaverse Space According to Example Embodiment

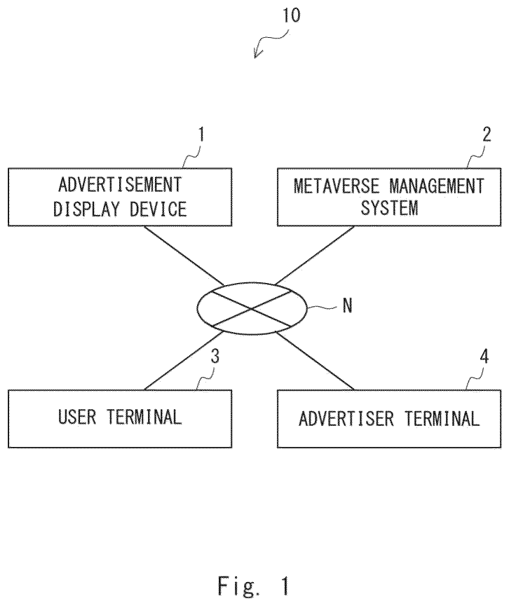

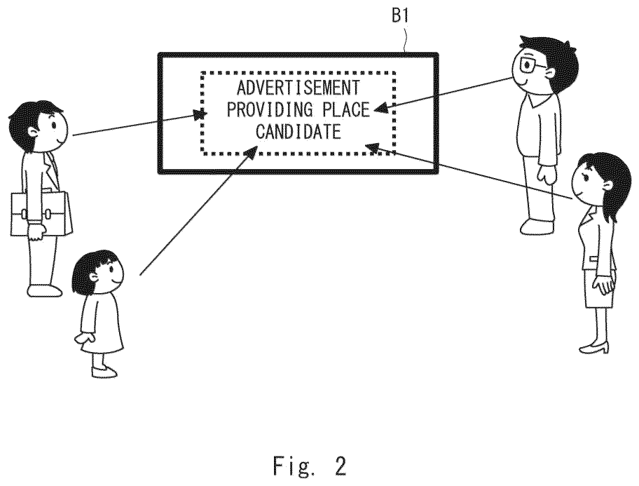

FIG. 1 is a diagram illustrating an outline of a metaverse space according to the present disclosure; FIG. 2 is a diagram illustrating a display of an advertisement in the metaverse space according to the present disclosure. With reference to FIGS. 1 and 2, a metaverse space according to an example embodiment will be described.

The metaverse space is a three-dimensional virtual space constructed on the Internet. The metaverse space can create a place to chat with voice or text by posting a space in which an individual arranges objects according to preference. The metaverse space creates an atmosphere such as academic, realistic, cyberpunk, lovely, urban, natural, and the like, and receives access from a person who likes the atmosphere.

As illustrated in FIG. 1, a metaverse 10 includes an advertisement display device 1, a metaverse management system 2, a user terminal 3, an advertiser terminal 4, and the like connected via a network N. The metaverse 10 may be connected to a metaverse poster terminal. The network N is the Internet such as a telephone line or an electric communication line.

The advertisement display device 1 is a device that displays an advertisement in a metaverse space created by an individual. The advertisement is a moving image or a still image with voice or without voice. Here, whether to display the advertisement is determined by a matching degree of attributes between the metaverse space and the advertisement. The advertisement display device 1 calculates an attribute of the metaverse space by Artificial Intelligence (AI) or the like. The advertisement display device 1 calculates an attribute of the advertisement by AI or the like, and displays the advertisement in a case where a similarity with the metaverse space is high by equal to or greater than a certain degree.

The metaverse management system 2 provides the metaverse space to an individual poster. The individual poster arranges the object in the metaverse space through the metaverse poster terminal. The creation of the atmosphere of the metaverse space is basically left to the discretion of an individual. Therefore, the metaverse management system 2 cannot control the arrangement of an unhealthy one in the metaverse space.

The user terminal 3 is a terminal of an individual that can enter a specific metaverse space and perform a chat or the like. The user can operate his/her own avatar in the metaverse space by using a personal computer (PC), a mobile terminal, a head mounted display, or the like. On the screen of the user terminal 3, the field of view of the avatar is displayed in a first-person view or a third-person view. For example, in a case where the user terminal 3 is a head mounted display, the user terminal 3 detects the movement of the head of the user and moves the field of view of the avatar. The head mounted display may also be able to track the gaze by tracking the movement of the user's iris.

As illustrated in FIG. 2, an advertisement may be reproduced in a case where a display object B1 imitating a display installed in the metaverse space is displayed on the display screen of the user terminal 3. The display portion of the advertisement may be determined by a direction when the user wearing the character or the head mounted display moves the face back and forth and left and right. In the metaverse space, the advertisement can be set to be distributed to the display object in a case where the display object B1 detects the gaze.

An advertiser terminal 4 is a terminal managed by an advertiser that inputs an advertisement. The advertiser cannot select a metaverse space in which to come out with an advertisement. However, the advertiser wants to display his/her advertisement in a metaverse space having a similar atmosphere. Therefore, there is a demand for a device that automatically evaluates the atmosphere of the metaverse space and comes out with an advertisement in the metaverse space having a similar evaluation.

### Description of Advertisement Display Device According to Example Embodiment

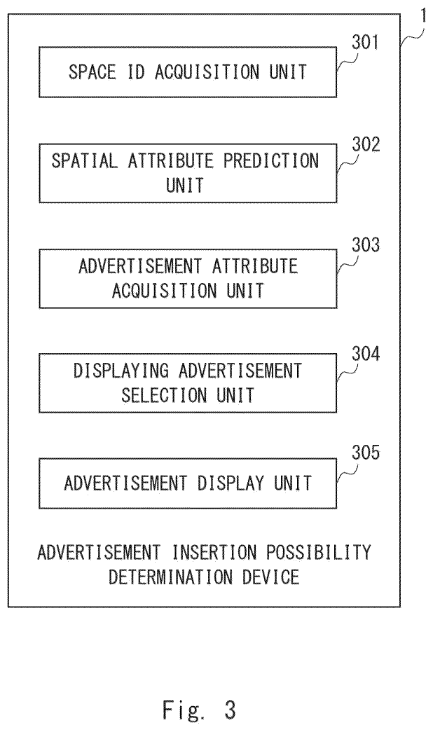

FIG. 3 is a block diagram illustrating a configuration of the advertisement display device according to the present disclosure. The advertisement display device according to the example embodiment will be described with reference to FIG. 3.

As illustrated in FIG. 3, the advertisement display device 1 includes a space ID acquisition unit 301, a spatial attribute prediction unit 302, an advertisement attribute acquisition unit 303, a displaying advertisement selection unit 304, and an advertisement display unit 305.

The space ID acquisition unit 301 acquires a space ID for specifying the metaverse space. A space ID is allocated to the metaverse space. The metaverse space can be specified by acquiring the space ID.

The spatial attribute prediction unit 302 predicts the spatial attribute based on the object information, the color information, and the theme in the metaverse space specified by acquiring the space ID. The object information is information related to a mode of a body arranged in the specified metaverse space, that is, an object. For example, the object is a building, an artificial object, a natural object such as a plant, an animal, or the like arranged in the metaverse space. The color information is information related to colors such as colors themselves used in the metaverse space, a ratio of each color, a color scheme, and brightness in the metaverse space. For example, the spatial attribute prediction unit 302 acquires the color information of the object as the color itself. The theme is a subject indicating the atmosphere of the space, such as academic, realistic, cyberpunk, lovely, urban, natural, and the like set in the metaverse space. The theme may be set by, for example, the creator and the user of the metaverse space, or the spatial attribute prediction unit 302 may comprehensively determine the theme from the explanatory sentence of the metaverse space, the object, the tendency of the user, and the like. In addition, a plurality of themes may be set for one metaverse space. The spatial attribute prediction unit 302 predicts the spatial attribute based on these. The spatial attribute prediction unit 302 inputs the object information, the color information, and the theme using Artificial Intelligence (AI), and outputs the spatial attribute.

The advertisement attribute acquisition unit 303 acquires attributes of candidates of a plurality of advertisements. The candidate of the advertisement is a candidate for which an advertisement is to be provided. The attribute of the advertisement is the same as the spatial attribute. The content of the advertisement is input using AI, and the attribute is output.

The displaying advertisement selection unit 304 selects an advertisement to display from the candidates of the plurality of advertisements based on the predicted spatial attribute and the plurality of advertisement attributes. The displaying advertisement selection unit selects an advertisement to display from candidates of a plurality of advertisements based on the matching degree of the spatial attribute and the advertisement attribute. If the matching degree between the spatial attribute and the advertisement attribute is high, the advertisement is selected in the metaverse space.

The advertisement display unit 305 displays the selected advertisement at a specific place in the metaverse space. For example, the advertisement display unit 305 displays a moving image or a still image in an area indicated by B1 in FIG. 2.

The spatial attribute prediction unit 302 may periodically predict the spatial attribute. The displaying advertisement selection unit 304 may select the advertisement if the number of candidates of the advertisement increases, if the number of candidates of the advertisement exceeds a predetermined number, or at predetermined timings such as 3 months, 6 months, or 1 year. In a case where there are a plurality of advertisement candidates having the same condition, the displaying advertisement selection unit 304 may preferentially select an advertisement with a higher advertisement fee that is paid by inserting an advertisement.

The space ID acquisition unit 301, the spatial attribute prediction unit 302, the advertisement attribute acquisition unit 303, the displaying advertisement selection unit 304, and the advertisement display unit 305 may each be reread as a space ID acquisition means, a spatial attribute prediction means, an advertisement attribute acquisition means, a displaying advertisement selection means, and an advertisement display means.

For example, in a case where only adult male users are gathered in a lovely space created by a female Vtuber, if an advertisement for shaving is issued because the user is a target, it does not adapt to the lovely space and the sense of immersion is inhibited. In this case, an advertisement that does not disturb a lovely atmosphere and targets an adult male is selected. For example, advertisement of Pokémon (registered trademark) or advertisement of chocolate is preferred by adult male, but does not destroy a lovely atmosphere.

For example, advertisement of a game easily harmonizes with an unrealistic world view such as cyberpunk or lovely. On the other hand, since advertisement of a game is not in harmony with the realistic world, nature, or the like, the advertisement of the game is not issued.

With the above configuration, it is possible to provide an advertisement display device that selects and displays an advertisement based on the spatial attribute of the metaverse space and the attribute of the advertisement.

### Description of Advertisement Display Method According to Example Embodiment

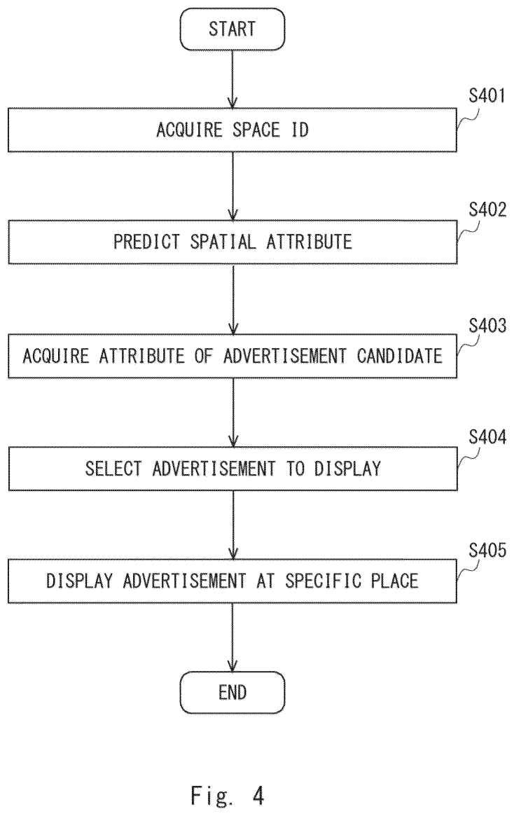

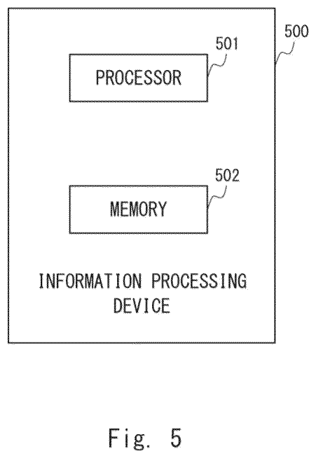

FIG. 4 is a flowchart of an advertisement display method according to the present disclosure. FIG. 5 is a block diagram illustrating a configuration of the information processing device according to the present disclosure. An advertisement display method according to the example embodiment will be described with reference to FIGS. 4 and 5.

As illustrated in FIG. 4, first, a space ID is acquired (step S401). The space ID acquisition unit 301 acquires a space ID for specifying the metaverse space. Next, a spatial attribute is predicted (step S402). The spatial attribute prediction unit 302 predicts the spatial attribute based on the object information, the color information, and the theme in the metaverse space specified by acquiring the space ID.

Next, an attribute of a candidate of an advertisement is acquired (step S403). The advertisement attribute acquisition unit 303 acquires attributes of candidates of a plurality of advertisements. Next, an advertisement to display is selected (step S404). The displaying advertisement selection unit 304 selects an advertisement to display from candidates of a plurality of advertisements based on the predicted spatial attribute and the attributes of the plurality of advertisements. Finally, the advertisement is displayed at a specific place (step S405). The advertisement display unit 305 displays the selected advertisement at a specific place in the metaverse space.

With the above configuration, it is possible to provide an advertisement display method that selects and displays an advertisement based on the spatial attribute of the metaverse space and the attribute of the advertisement.

The above method is achieved by executing a program in the information processing device. As illustrated in FIG. 5, the information processing device 500 according to the example embodiment includes a processor 501 that physically executes a program to perform processing, and a memory 502 that stores the program. The information processing device 500 may include one device or a plurality of devices. The information processing device 500 may be a cloud server that processes some or all of the functions in a distributed manner. The information processing device 500 may be reread as the advertisement display device 1.

Some or all of the processing in the advertisement display device 1 and the information processing device 500 described above can be achieved as a computer program. Such a program can be stored and supplied to the computer using various types of non-transitory computer-readable media. The non-transitory computer-readable media include various types of tangible recording media. Examples of the non-transitory computer-readable media include a magnetic recording medium (e.g., a flexible disk, a magnetic tape, a hard disk drive), a magneto-optical recording medium (e.g., a magneto-optical disc), a CD-Read Only Memory (ROM), a CD-R, a CD-R/W, and a semiconductor memory (e.g., a mask ROM, a Programmable ROM (PROM), an Erasable PROM (EPROM), a flash ROM, or a Random Access Memory (RAM)). The program may be supplied to the computer using various types of transitory computer-readable media. Examples of the transitory computer-readable media include electric signals, optical signals, and electromagnetic waves. The transitory computer-readable medium can supply the programs to the computer via a wired communication path such as an electric wire and an optical fiber or a wireless communication path.

### Description of Advertisement Display Device According to First Example Embodiment

The advertisement display device according to a first example embodiment may have a function of selecting not only the advertisement display but also the voice of the advertisement based on the spatial attribute, and adjusting to harmonize with the background sound or the sound effect in the space. If a mismatch between the atmosphere of the space and the voice of the advertisement occurs, there is a possibility that the user's space experience deteriorates.

First, voice data of the selected advertisement is acquired. Next, the voice data is adjusted based on the background sound or the sound effect in the space. Then, the advertisement is displayed together with the adjusted voice.

With the above configuration, the advertisement including the voice element is harmonized with the atmosphere of the space, and the immersion feeling of the user can be further enhanced.

### Description of Advertisement Display Device According to Another Example Embodiment

An advertisement display device according to another example embodiment will be described.

The spatial attribute prediction unit 302 may predict the spatial attribute based on the data of the user behavior. The user behavior is a speech history of the user in the metaverse space, an entry/exit history of the metaverse space, a history of viewing the advertisement, an attraction participation history, and the like. The spatial attribute prediction unit 302 can predict the spatial attribute in accordance with the user behavior.

The advertisement display device 1 may further include a configuration file reading unit that reads a configuration file including an advertisement presentation condition set in advance by a space creator who created the metaverse space. The displaying advertisement selection unit selects an advertisement to display based on the advertisement presentation condition. In this way, it is possible to display an advertisement complying with the intention of the space creator.

The advertisement display unit may adjust the voice of the selected advertisement in such a way as to harmonize with the background sound and the sound effect in the metaverse space. The advertisement display device 1 can produce a harmonized metaverse space.

The advertisement display device 1 may further include a log data collection unit that collects a reaction of the user with respect to the displayed advertisement as log data. The collected log data is fed back to the display target advertisement selection unit. In this way, the advertisement display device 1 can display an advertisement with a good reaction of the user.

The configuration file reading unit and the log data collection unit may be reread as a configuration file reading means and a log data collection means, respectively.

Furthermore, the spatial attribute prediction unit 302 may predict the spatial attribute based on the text, the evaluation of the user, the voice content, and the communication history. Based on the communication history means based on the content of a conversation that is communication between the users. For example, the spatial attribute of a space for a family (family), a space for a child, a space for a couple or a married couple, a space for an adult male, a space for an adult female, or the like is predicted according to the conversation content.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the example embodiments described above may also be described as, but are not limited to, the following Supplementary Notes.

### Supplementary Note 1

An advertisement display device including
a space ID acquisition unit that acquires a space ID specifying a metaverse space,
a spatial attribute prediction unit that predicts a spatial attribute based on object information, color information, and theme in the metaverse space specified by acquiring the space ID,
an advertisement attribute acquisition unit that acquires attributes of candidates of a plurality of the advertisements,
a displaying advertisement selection unit that selects an advertisement to display from the candidates of the plurality of the advertisements based on the predicted spatial attribute and the attributes of the plurality of the advertisements, and
an advertisement display unit that displays the selected advertisement at a specific place in the metaverse space.

### Supplementary Note 2

The advertisement display device according to supplementary note 1, in which the spatial attribute prediction unit predicts the spatial attribute based on data of a user behavior.

### Supplementary Note 3

The advertisement display device according to supplementary note 1, further including a configuration file reading unit that reads a configuration file including an advertisement presentation condition set in advance by a space creator who created the metaverse space,
in which the displaying advertisement selection unit selects an advertisement to display based on the advertisement presentation condition.

### Supplementary Note 4

The advertisement display device according to supplementary note 1, in which the advertisement display unit adjusts a voice of a selected advertisement in such a way as to harmonize with a background sound and a sound effect in the metaverse space.

### Supplementary Note 5

The advertisement display device according to supplementary note 1, further including a log data collection unit that collects a reaction of the user with respect to the displayed advertisement as log data,
in which the collected log data is fed back to a display target advertisement selection unit.

### Supplementary Note 6

An advertisement display method including
acquiring a space ID specifying a metaverse space,
predicting a spatial attribute based on object information, color information, and theme in the metaverse space specified by acquiring the space ID,
acquiring attributes of candidates of a plurality of the advertisements,
selecting an advertisement to display from the candidates of the plurality of the advertisements based on the predicted spatial attribute and the attributes of the plurality of the advertisements, and
displaying the selected advertisement at a specific place in the metaverse space.

### Supplementary Note 7

The advertisement display method according to supplementary note 6, in which predicting the spatial attribute includes predicting the spatial attribute based on data of a user behavior.

### Supplementary Note 8

The advertisement display method according to supplementary note 6, further including reading a configuration file including an advertisement presentation condition set in advance by a space creator who created the metaverse space,
in which selecting the advertisement to display includes selecting an advertisement to display based on the advertisement presentation condition.

### Supplementary Note 9

The advertisement display method according to supplementary note 6, in which displaying the advertisement includes adjusting a voice of a selected advertisement in such a way as to harmonize with a background sound and a sound effect in the metaverse space.

### Supplementary Note 10

A program for causing an information processing device to execute
acquiring a space ID specifying a metaverse space,
predicting a spatial attribute based on object information, color information, and theme in the metaverse space specified by acquiring the space ID,
acquiring attributes of candidates of a plurality of the advertisements,
selecting an advertisement to display from the candidates of the plurality of the advertisements based on the predicted spatial attribute and the attributes of the plurality of the advertisements, and
displaying the selected advertisement at a specific place in the metaverse space.

Some or all of the elements (e.g., configurations and functions) described in supplementary notes 2 to 5 dependent on supplementary note 1 {e.g. device} can also be dependent on supplementary note 6 {e.g. method} and supplementary note 10 {e.g. program} by the same dependency relationship as supplementary notes 2 to 5. Some or all of the elements described in any supplementary note may be applied to various types of hardware, software, recording means for recording software, systems, and methods.

What is claimed is:

1. An advertisement display device comprising:
a memory configured to store instructions; and
a processor configured to execute the instructions to:
acquire a space ID specifying a metaverse space;
predict a spatial attribute based on object information, color information, and theme in the metaverse space specified by acquiring the space ID;
acquire attributes of candidates of a plurality of the advertisements;
select an advertisement to display from the candidates of the plurality of the advertisements based on the predicted spatial attribute and the attributes of the plurality of the advertisements; and
display the selected advertisement at a specific place in the metaverse space.

2. The advertisement display device according to claim 1, wherein the predicting the spatial attribute predicts the spatial attribute based on data of a user behavior.

3. The advertisement display device according to claim 1, wherein further the processor configured to execute the instructions to;
read a configuration file including an advertisement presentation condition set in advance by a space creator who created the metaverse space,
wherein displaying the selected advertisement selects an advertisement to display based on the advertisement presentation condition.

4. The advertisement display device according to claim 1, wherein displaying the selected advertisement adjusts a voice of a selected advertisement in such a way as to harmonize with a background sound and a sound effect in the metaverse space.

5. The advertisement display device according to claim 1, wherein further the processor configured to execute the instructions to;
collect a reaction of the user with respect to the displayed advertisement as log data,
wherein the collected log data is fed back to a display target advertisement selection unit.

6. An advertisement display method comprising:
acquiring a space ID specifying a metaverse space;
predicting a spatial attribute based on object information, color information, and theme in the metaverse space specified by acquiring the space ID;
acquiring attributes of candidates of a plurality of the advertisements;
selecting an advertisement to display from the candidates of the plurality of the advertisements based on the predicted spatial attribute and the attributes of the plurality of the advertisements; and
displaying the selected advertisement at a specific place in the metaverse space.

7. The advertisement display method according to claim 6, wherein predicting the spatial attribute includes predicting the spatial attribute based on data of a user behavior.

8. The advertisement display method according to claim 6, further comprising reading a configuration file including an advertisement presentation condition set in advance by a space creator who created the metaverse space,
wherein selecting the advertisement to display includes selecting an advertisement to display based on the advertisement presentation condition.

9. The advertisement display method according to claim 6, wherein displaying the advertisement includes adjusting a voice of a selected advertisement in such a way as to harmonize with a background sound and a sound effect in the metaverse space.

10. The advertisement display method according to claim 6, further comprising collecting a reaction of the user with respect to the displayed advertisement as log data,
wherein the collected log data is fed back to step of selecting the advertisement.

11. A non-transitory computer-readable medium storing a program for causing an information processing device to execute:
acquiring a space ID specifying a metaverse space,
predicting a spatial attribute based on object information, color information, and theme in the metaverse space specified by acquiring the space ID,
acquiring attributes of candidates of a plurality of the advertisements,
selecting an advertisement to display from the candidates of the plurality of the advertisements based on the predicted spatial attribute and the attributes of the plurality of the advertisements, and
displaying the selected advertisement at a specific place in the metaverse space.

12. The non-transitory computer-readable medium storing the program according to claim 11, wherein predicting the spatial attribute includes predicting the spatial attribute based on data of a user behavior.

13. The non-transitory computer-readable medium storing the program according to claim 11, further comprising reading a configuration file including an advertisement presentation condition set in advance by a space creator who created the metaverse space,
wherein selecting the advertisement to display includes selecting an advertisement to display based on the advertisement presentation condition.

14. The non-transitory computer-readable medium storing the program according to claim 11, wherein displaying the advertisement includes adjusting a voice of a selected advertisement in such a way as to harmonize with a background sound and a sound effect in the metaverse space.

15. The non-transitory computer-readable medium storing the program according to claim 11, further comprising collecting a reaction of the user with respect to the displayed advertisement as log data,
wherein the collected log data is fed back to step of selecting the advertisement.
